(19) United States
(12) Patent Application Publication
(10) Pub. No.: US 2006/0143076 A1
(43) Pub. Date: Jun. 29, 2006

(54) Method of advertising

(76) Inventor: Edward Stafford, Dallas, TX (US)

Correspondence Address: GARU C. HONEYCUTT, 4728 RAVENDALE, RICHARDSON, TX, 75082, US

(21) Appl. No.: 11/019,471

(22) Filed: Dec. 23, 2004

(51) Int. Cl. G06Q 30/00; B21F 45/02

(52) U.S. Cl. 705/14; 140/81.5

(57) ABSTRACT

A method of distributing advertisements, including the steps of placing ads on garment hangers, arranging the hangers ads in a collated sequence, and delivering the collated hanger ads for retail distribution.

### FIELD OF THE INVENTION

This invention relates to advertising, and more particularly to a method of distributing ads in a cost effective manner.

### BACKGROUND OF THE INVENTION

Printed ads have been distributed in various ways. There has always been a realization that home delivery of ads is effective. The most common method of home delivery is through the mail. But the cost of such delivery is considered high, especially when each advertisement is mailed separately. Recently it has become popular to hire a middle-man for home delivery of ads, so that ads from multiple sources can be packaged and mailed together. This may save on the cost of postage, but it is not necessarily effective, since a large percentage of such packages are never opened. Over a period of time, people become even less likely to open the packages, so that still fewer ads are viewed.

### SUMMARY OF THE INVENTION

The method of the invention includes the steps of placing a plurality of different ads on a plurality of garment hangers, and arranging the hangers in a collated ad sequence for delivery to laundry and dry cleaning shops, or to other retail shops. The hanger ads are then distributed to shop customers when they purchase clothes, or when customers pick up their clothes from a laundry or dry cleaning shop.

For example, if five companies participate in the service, and five hundred hangers are packaged in a single box, each company ad will appear on one hundred hangers in each box. When a customer picks up five garments, for example, each of the five hangers must carry a different ad, in order to achieve optimum distribution. One could pay the shops to carefully select an optimum distribution of hanger ads, but that would not be cost-effective. In accordance with this invention, the hangers are arranged in a collated sequence, so that the shop clerks are not required to pay any attention to the ads. That is, whenever five hangers are removed from the box, it is normal for the clerk to take the next five hangers, in the same order they were packaged, which means that all five ads are present in each group of five taken from the box. Of course, some customers will have more than five items, and will receive one or more duplicate ads. If a customer has fewer than five items, they will not receive all five ads, but the overall distribution among hundreds of customers is still effective.

One aspect of the invention is a plurality of garment hangers bearing a plurality of advertisements arranged in a collated sequence, for delivery to a laundry and/or a dry cleaning shop, or other retail shop, where the hangers will then be distributed to their customers. Generally, the shop clerks will distribute the hangers in the same sequence, as packaged, without paying any attention to the sequence.

### BRIEF DESCRIPTION OF THE DRAWING

FIG. 1 is a schematic view of the method of the invention, including a perspective view of the packaged hangers, arranged in a collated sequence.

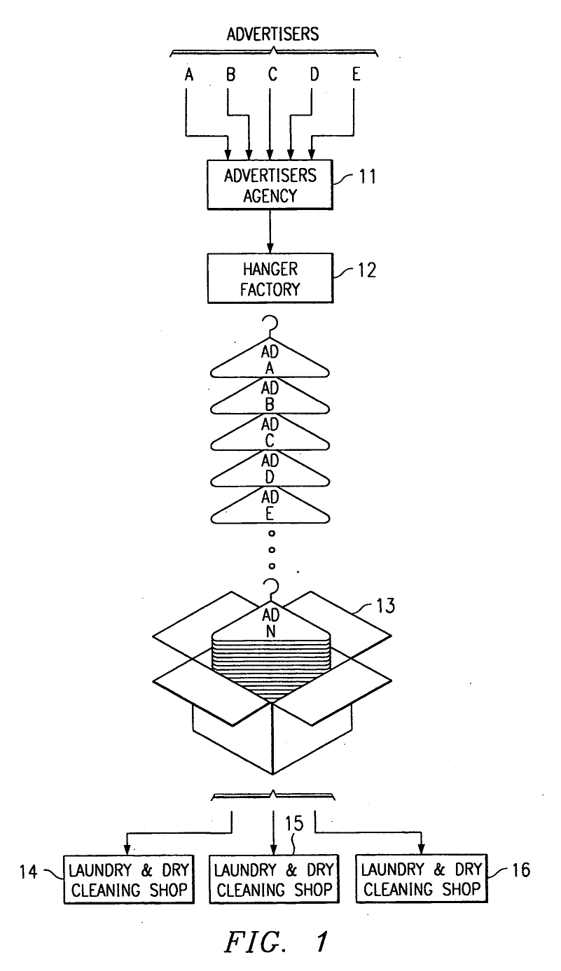

### DETAILED DESCRIPTION OF THE PREFERRED EMBODIMENT

As shown in the drawing, advertising agency 11 obtains or creates one or more separate ad for each of five advertisers A, B, C, D and E. The agency then places an order with a suitable hanger factory 12 for the manufacture of hangers that include the advertisements. For example, each hanger carries an ad printed on a paper jacket. The factory collates the hanger ads, as shown, so that the ad sequence A, B, C, D and E is repeated again and again. The hangers are then placed in a container 13 for delivery to retail shops 14, 15 and 16. The shop clerks will generally remove and use the hangers in the same sequence, as packaged, without having to pay any attention to the sequence.

Five advertisements are selected for purposes of illustration. But the method is cost-effective for any number of ads, from only two, for example, up to five hundred or more. However, since a large number of ads gives each advertiser a smaller share of the total, it is not practical to exceed 20 or 30 ads in a package.

What is claimed is:

1. A plurality of garment hangers, and a plurality of advertisements distributed on said hangers, wherein adjacent hangers carry a different advertisement, said hangers arranged in a collated sequence.

2. A plurality of hangers and advertisements, arranged as in claim 1, packaged in a box.

3. A method of distributing advertisements, comprising the steps of:
placing a plurality of advertisements on a plurality of garment hangers;
arranging said hangers in a collated sequence; and
delivering said hangers to a store for distribution to customers.

4. A method as in claim 3, wherein said store is a laundry.

5. A method as in claim 3, wherein said store is a dry cleaning shop.
